(19) United States
(12) Patent Application Publication
(10) Pub. No.: US 2024/0384061 A1
(43) Pub. Date: Nov. 21, 2024

(54) COMPOSITE POLYMER FILM MATERIAL BASED ON TUNGSTEN/COPPER/SULFUR CLUSTER COMPOUND, PREPARATION METHOD AND USE THEREOF IN THIRD-ORDER NONLINEAR OPTICS

(71) Applicant: SOOCHOW UNIVERSITY, Suzhou (CN)

(72) Inventors: Jianping LANG, Suzhou (CN); Shujin BAO, Suzhou (CN); Zeming XU, Suzhou (CN); Chunyan NI, Suzhou (CN)

(21) Appl. No.: 18/608,048

(22) Filed: Mar. 18, 2024

Related U.S. Application Data
(63) Continuation of application No. PCT/CN2023/106898, filed on Jul. 12, 2023.

(30) Foreign Application Priority Data
Jul. 13, 2022 (CN) 202210821687.X

(51) Int. Cl. C08K 5/00; C07F 11/00; C08J 5/18; G02F 1/361

(52) U.S. Cl. CPC C08K 5/0091; C07F 11/005; C08J 5/18; G02F 1/3615; C08J 2329/04

(57) ABSTRACT

The invention provides a composite polymer film material based on a tungsten/copper/sulfur cluster compound, a preparation method and use thereof. The cluster compound has a chemical formula of: [RWS₃Cu₂(L^{a})]ₙ(M)ₙ, wherein R is tris(3,5-dimethylpyrazolyl)hydroborate, tris(pyrazolyl)hydroborate, or pentamethylcyclopentadienyl; L^{a} has a structural formula of:

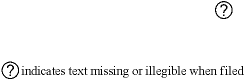

when M is perrhenate, n is 4; and when M is triflate, n is 6. The synthesis process of the cluster compound is simple and controllable. A tetrahedral and an octahedral tungsten/copper/sulfur cluster compound that are good third-order nonlinear optical (NLO) active species are selectively synthesized by using different cuprous salts. Composite polymer films of various layers are prepared by spin coating. Such films, as flexible, portable and easy-to-process solid materials, are applicable to third-order NLO devices. With increasing layers in the film, the third-order NLO response is gradually enhanced, and is 3-4 orders of magnitude higher than a solution containing the cluster compound.

### FIELD OF THE INVENTION

The present invention relates to the field of metal cluster compounds and use thereof in third-order nonlinear optics, and particularly to a composite polymer film material based on a tungsten/copper/sulfur cluster compound, and a preparation method and use thereof in third-order nonlinear optics.

### DESCRIPTION OF THE RELATED ART

With the great advancement of science and technology, particularly the rapid development of optical information technology, the interest of research on photonic devices is aroused (see: F. Jedema, Nat. Mater., 2007, 6, 90-91). Photonic devices are the key to realize optical information processing and optical computing, and third-order nonlinear optical (NLO) materials are the basis for studying and realizing photonic devices such as optical logic, optical storage, optical triode and optical switch. Therefore, the development of optical materials with good third-order NLO response has always been a focus of research of the material scientists (see: J. M. Hales, J. Matichak, S. Barlow, S. Ohira, K. Yesudas, J. L. Brédas, J. W. Perry, S. R. Marder, Science, 2010, 327, 1485-1488). In the past ten years, various organic/inorganic and hybrid materials have been designed, synthesized and used to study the third-order NLO performances, including conjugated organic molecules, graphene, carbon nanotubes, polymers, metal complexes, metal nanoclusters and metal-organic frameworks (see: Y. P. He, G. H. Chen, D. J. Li, Q. H. Li, L. Zhang, J. Zhang, Angew. Chem. Int. Ed., 2021, 60, 2920-2923).

The tungsten/copper/sulfur cluster compounds are also a kind of third-order NLO materials with good prospects of development. These compounds usually have highly delocalized dπ-pπ and highly conjugated dπ-dπ systems (see: W. H. Zhang, Z. G. Ren, J. P. Lang, Chem. Soc. Rev., 2016, 45, 4995-5019). However, at present, the research on NLO performances is limited to solutions and the NLO response is mostly weak, so it is difficult to realize its use in nonlinear optical devices. It is well known that the morphology of molecular materials is critical to their physical and chemical properties. Solid materials can show different or completely opposite properties from the dispersed solutions because of their closely packed structures, and the solid materials are easy to process, so the functionalization and unitization of the materials can be well realized (see: Q. C. Peng, L. P. Yang, Y. Y. Li, Y. Zhang, T. H. Li, Y. J. Qin, Y. L. Song, H. W. Hou, K. Li, J. Phys. Chem. C, 2020, 124, 22684-22691). Therefore, it is of great significance to develop solid-state materials with good third-order NLO response for the development of NLO devices.

In recent years, organic polymer films have attracted extensive attention because of their good flexibility, portability, and high transparency. By introducing a target compound into such a polymer substrate to form a uniform solid polymer film material, the stability of the obtained material can be effectively improved and the degree of light scattering is reduced (see: D. J. Li, Q. H. Li, Z. R. Wang, Z. Z. Ma, Z. G. Gu, J. Zhang, J. Am. Chem. Soc. 2021, 143, 17162-17169). Such solid polymer film material has great potential of development in the manufacturing and development of practical nonlinear optical devices. However, so far, this composite membrane material has not shown highly enhanced NLO performance. In fact, there are few reported examples of thin films with NLO response that is thousands or even tens of thousands of times higher than the corresponding solutions. Therefore, it is of great significance to introduce a material with low NLO activity, such as tungsten/copper/sulfur cluster compound, into a polymer substrate, to form a new composite film that can significantly amplify NLO response in multiple orders of magnitude.

### SUMMARY OF THE INVENTION

To solve the above technical problems, the present invention provides a composite polymer film material based on a tungsten/copper/sulfur cluster compound, a preparation method and use thereof in third-order nonlinear optics.

A first object of the present invention is to provide a polyhedral tungsten/copper/sulfur cluster compound. The cluster compound has a chemical formula of: [RWS₃Cu₂(L^{a})]ₙ(M)ₙ,
where R is tris(3,5-dimethylpyrazolyl) hydroborate (Tp*), tris(pyrazolyl) hydroborate (Tp), or pentamethylcyclopentadienyl (Cp*);
L^{a} has a structural formula of:
M is selected from triflate (OTf⁻) and perrhenate (ReO₄⁻), in which when M is ReO₄⁻, n is 4; and when M is OTf⁻, n is 6.

In an embodiment of the present invention, the polyhedral is tetrahedral or octahedral.

A second object of the present invention is to provide a method for preparing the polyhedral tungsten/copper/sulfur cluster compound. The method includes the following steps: adding a metal sulfur-containing synthon [Et₄N][RWS₃], a ligand L and a cuprous salt to a solvent mixture, and reacting with stirring, subjecting the reaction solution to solid-liquid separation, collecting the filtrate, and diffusing with a diffusing agent, to precipitate the polyhedral tungsten/copper/sulfur cluster compound. The ligand L is 1,4-di(pyridin-4-yl) buta-1,3-diyne.

In an embodiment of the present invention, the diffusing agent is ether.

In an embodiment of the present invention, the molar ratio of the metal sulfur-containing synthon [Et₄N][RWS₃], the ligand L and the cuprous salt is (1-1.5): (1-1.5):(2-2.5).

In an embodiment of the present invention, the solvent mixture is obtained by mixing dichloromethane and acetonitrile in a volume ratio of (4-5):(1-1.5).

In an embodiment of the present invention, the cuprous salt is selected from [Cu(CH₃CN)₄]ReO₄, and [Cu(CH₃CN)₄]OTf.

A third object of the present invention is to provide a composite polymer film material including the polyhedral tungsten/copper/sulfur cluster compound.

A fourth object of the present invention is to provide a method for preparing the composite polymer film material. The method includes the following steps: adding a solution of a polyhedral tungsten/copper/sulfur cluster compound to a high molecular polymer solution, mixing uniformly, spin coating the obtained liquid onto a substrate, and thermally treating, to obtain the composite polymer film material.

In an embodiment of the present invention, the high molecular polymer is selected from the group consisting of polyvinyl alcohol (PVA), polymethyl methacrylate, polyimide, polyacrylic alcohol and any combination thereof.

In an embodiment of the present invention, the high molecular polymer solution has a concentration of 5.0×10⁻⁴-1.0×10⁻³ mol/L.

In an embodiment of the present invention, the concentration of the solution of the polyhedral tungsten/copper/sulfur cluster compound is 1.6×10⁻³-4.0×10⁻³ mol/L.

In an embodiment of the present invention, the composite polymer film material includes at least 2 layers.

A fifth object of the present invention is to provide use of the composite polymer film material in the preparation of a third-order nonlinear optical material.

Compared with the prior art, the technical solution of the present invention has the following advantages:

The synthesis process of the tetrahedral and octahedral tungsten/copper/sulfur cluster compounds according to the present invention is simple and controllable. A tetrahedral and an octahedral tungsten/copper/sulfur cluster compound can be selectively synthesized by using cuprous salts with different anions. The rigid backbone of these compounds contains many heavy metal atom centers and highly conjugated organic connecting units, so they are potential third-order nonlinear optical materials. The preparation method of the composite polymer film material with different layers based on the polyhedral tungsten/copper/sulfur cluster compound is simple in process, and a composite polymer film material can be obtained by conventional spin coating and heat treatment operations. The method can be used for large-scale and large-area preparation. Composite polymer films having two or more layers with different loads can be obtained by increasing the number of spin coating. As a flexible, portable and easy-to-process solid material, the prepared tungsten/copper/sulfur cluster compound@polyvinyl alcohol composite polymer film is applicable to third-order NLO devices. With increasing layers of the film, the third-order NLO response of the composite polymer film material prepared in the present invention gradually increases. This is caused by the increasing load of the tungsten/copper/sulfur cluster compound. Particularly, compared with the solution, the third-order NLO response of the composite film prepared by spin coating to have 12 layers is improved by four orders of magnitude, which contributes to the development of third-order nonlinear optical devices with excellent performance.

### BRIEF DESCRIPTION OF THE DRAWINGS

To make the disclosure of the present invention more comprehensible, the present invention will be further described in detail by way of specific embodiments of the present invention with reference the accompanying drawings, in which:

FIG. 1 is a schematic diagram showing the assembly of [1](ReO₄)₄ and [2](OTf)₆ in Examples 1 and 2;

FIG. 2 schematically shows the crystal structure of [1](ReO₄)₄ in Example 1;

FIG. 3 schematically shows the crystal structure of [2](OTf)₆ in Example 2;

FIG. 4 shows the third-order NLO response of DMF solutions of [1](ReO₄)₄ and [2](OTf)₆ under open-aperture test conditions in Example 3, in which FIG. 4a is a Z-scan scattergram of DMF solutions of [1](ReO₄)₄ and [2](OTf)₆ under open-aperture test conditions, and FIG. 4b is a histogram showing the third-order NLO parameters (minimum normalized transmittance Tₘᵢₙ and effective nonlinear absorption coefficient β) of DMF solutions of [1](ReO₄)₄ and [2](OTf)₆;

FIG. 5 is a schematic diagram showing the preparation process of [1](ReO₄)₄@PVA and [2](OTf)₆@PVA composite polymer films in Example 4;

FIG. 6 shows the third-order NLO response of [1](ReO₄)₄@PVA and [2](OTf)₆@PVA composite polymer films spin-coated to have different layers under open-aperture test conditions in Example 5, in which FIG. 6a is a Z-scan scattergram of [1](ReO₄)₄@PVA composite polymer films spin-coated to have 2, 4, 6, 8, 10 and 12 layers under open-aperture test conditions, FIG. 6b is a Z-scan scattergram of [2](OTf)₆@PVA composite polymer films spin-coated to have 2, 4, 6, 8, 10 and 12 layers under open-aperture test conditions, FIG. 6c is a histogram showing the third-order NLO parameters (minimum normalized transmittance Tₘᵢₙ and effective nonlinear absorption coefficient β) of [1](ReO₄)₄@PVA composite polymer films, and FIG. 6d is a histogram showing the third-order NLO parameters (minimum normalized transmittance Tₘᵢₙ and effective nonlinear absorption coefficient β) of [2](OTf)₆@PVA composite polymer films.

### DETAILED DESCRIPTION OF THE PREFERRED EMBODIMENTS

The present invention will be further described below with reference to the accompanying drawings and specific examples, so that those skilled in the art can better understand and implement the present invention; however, the present invention is not limited thereto.

### EXAMPLE 1

### Preparation of Tetrahedral Tungsten/Copper/Sulfur Cluster Compound [1](ReO₄)₄

At room temperature, a metal sulfur-containing synthon [Et₄N][Tp*WS₃] (0.071 g, 0.10 mmol), a cuprous salt [Cu(CH₃CN)₄]ReO₄ (0.096 g, 0.20 mmol) and a ligand L (0.020 g, 0.10 mmol) were dissolved in a solvent mixture of dichloromethane/acetonitrile (40 mL/10 mL), and magnetically stirred for about six hours. After the reaction, the reaction solution was filtered and a dark-red filtrate was obtained. The filtrate was placed in a glass tube, and 25 mL of ether was covered on the top of the filtrate by diffusion method. After one week, a long, black-red crystal [1](ReO₄)₄ was precipitated on the tube wall. The crystal was collected, washed thoroughly with ether, and finally dried in a constant temperature oven at 60° C. Yield: 0.335 g (83%, based on [Et₄N][Tp*WS₃])

Element analysis (%): C₁₁₆H₁₂₀B₄Cu₈N₃₂O₁₆Re₄S₁₂W₄ (M.W.=4634.91), Calculated: C, 30.06; H, 2.61; N, 9.67%; Found: 30.33; H, 2.87; N, 9.51%.

Infrared spectrum (potassium bromide disk method): 3446 (s), 2962 (w), 2922 (w), 2852 (w), 2555 (w), 2181 (w), 1608 (s), 1544 (s), 1495 (w), 1449 (m), 1415 (s), 1384 (w), 1355 (s), 1214 (s), 1112 (w), 1065 (m), 1038 (m), 982 (w), 910 (vs), 856 (m), 825 (m), 790 (w), 692 (w), 642 (w), 544 (w) cm⁻¹.

Electrospray ionization mass spectrometry (ESI-TOF MS): m/z=1294.5472 ({[1](ReO₄)}³⁺ calculated: 1294.6398), 2067.0724 ({[1](ReO₄)₂}²⁺ calculated: 2066.9229).

¹H NMR spectrum (600 MHz, CD₃CN, ppm): δ 8.72 (d, J=6 Hz, 8H), 8.09 (s, 8H), 7.75 (d, J=6 Hz, 16H), 6.31 (s, 4H), 6.21 (s, 4H), 5.78 (s, 4H), 3.09 (s, 12H), 2.79 (s, 12H), 2.72 (s, 12H), 2.70 (s, 12H), 2.30 (s, 12H), 1.88 (s, 12H).

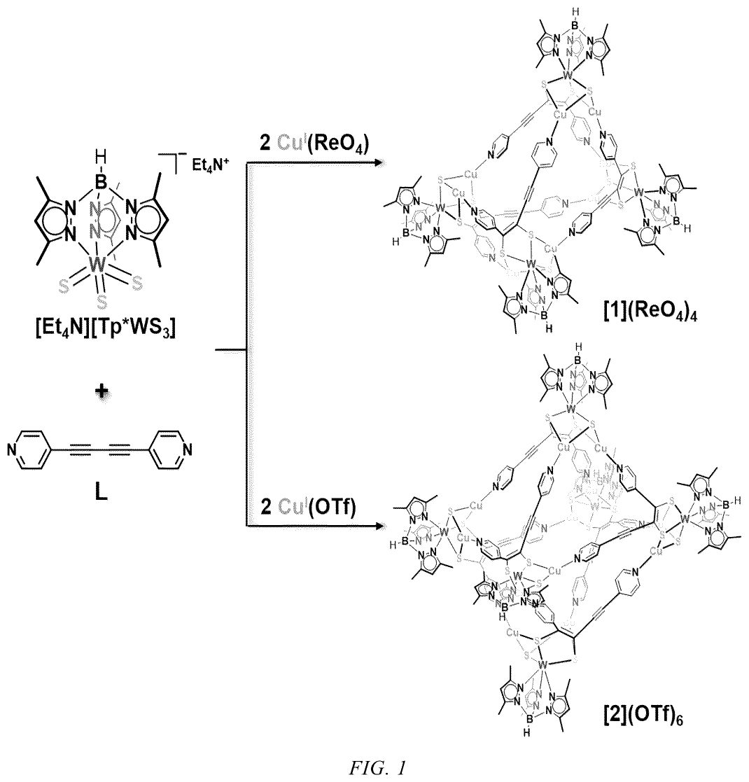

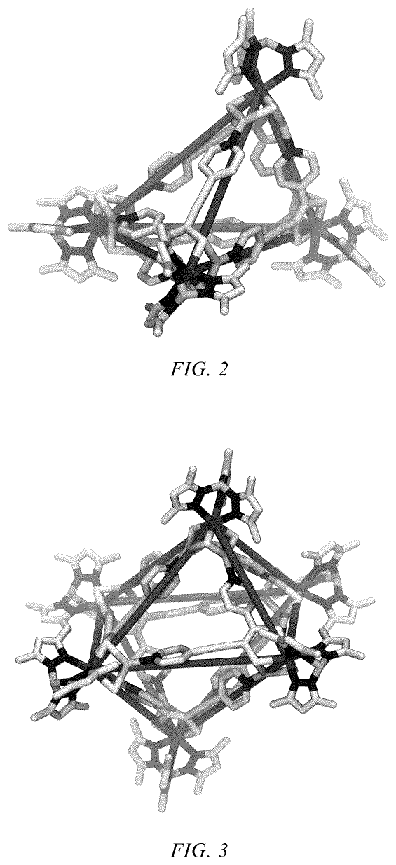

The assembly process is shown in FIG. 1 below. The product was tested by X-ray single crystal diffraction. The crystallographic parameters are listed in Table 1. The cation skeleton structure of the tetrahedral tungsten/copper/sulfur cluster compound [1](ReO₄)₄ is shown in FIG. 2.

TABLE 1
Crystallographic parameters of cluster compound [1](ReO₄)₄

| Compound | [1](ReO₄)₄ |
|---|---|
| Molecular formula | C₁₁₆H₁₂₀B₄Cu₈N₃₂O₁₆Re₄S₁₂W₄ |
| Molecular weight | 4634.91 |
| Crystal system | Triclinic crystal system |
| Space group | P1̅ |
| a/Å | 18.4637(19) |
| b/Å | 19.203(2) |
| c/Å | 23.928(3) |
| α/° | 92.015(3) |
| β/° | 102.688(4) |
| γ/° | 90.308(3) |
| V/Å³ | 8270.6(15) |
| D_{c}/g cm⁻³ | 1.861 |
| Z | 2 |
| μ (Mo—Kα)/mm⁻¹ | 6.897 |
| Total number of diffraction points | 85432 |
| Number of independent | 37519 |
| diffraction points | |
| F(000) | 4416.0 |
| R₁^{a} | 0.0774 |
| wR₂^{b} | 0.1912 |
| GOF^{c} | 1.028 |

The data shows that the tetrahedral tungsten/copper/sulfur cluster compound [Tp*WS₃Cu₂(L^{a})]₄(ReO₄)₄, that is, [1](ReO₄)₄, is successfully obtained in this example.

### EXAMPLE 2

### Preparation of Octahedral Tungsten/Copper/Sulfur Cluster Compound [2](OTf)₆

At room temperature, a metal sulfur-containing synthon [Et₄N][Tp*WS₃] (0.071 g, 0.10 mmol), a cuprous salt [Cu(CH₃CN)₄]OTf (0.075 g, 0.20 mmol) and a ligand L (0.020 g, 0.10 mmol) were dissolved in a solvent mixture of dichloromethane/acetonitrile (40 mL/10 mL), and magnetically stirred for about six hours. After the reaction, the reaction solution was filtered and a dark-red filtrate was obtained. The filtrate was placed in a glass tube, and 25 mL of ether was covered on the top of the filtrate by diffusion method. After one week, a black-red hexagonal flake-like crystal [2](OTf)₆ was precipitated on the tube wall. The crystal was collected, washed thoroughly with ether, and finally dried in a constant temperature oven at 60° C. Yield: 0.536 g (78%, based on [Et₄N][Tp*WS₃]).

The assembly process is shown in FIG. 1 below. [2](OTf)₆ was characterized by X-ray single crystal diffraction, elemental analysis, infrared spectroscopy, electrospray ionization mass spectrometry and nuclear magnetic resonance spectroscopy. The specific process is as follows.

TABLE 2
Crystallographic parameters of cluster compound [2](OTf)₆

| Compound | [2](OTf)₆ |
|---|---|
| Molecular formula | C₁₈₀H₁₈₀B₆Cu₁₂F₁₈N₄₈O₁₈S₂₄W₆ |
| Molecular weight | 6345.59 |
| Crystal system | Trigonal system |
| Space group | R3̅ |
| a/Å | 20.1017(7) |
| b/Å | 20.1017(7) |
| c/Å | 71.799(5) |
| α/° | 90 |
| β/° | 90 |
| γ/° | 120 |
| V/Å³ | 25125(2) |
| D_{c}/g cm⁻³ | 1.258 |
| Z | 3 |
| μ (Mo—Kα)/mm⁻¹ | 2.999 |
| Total number of diffraction | 294150 |
| points | |
| Number of independent | 12890 |
| diffraction points | |
| F(000) | 9324.0 |
| R₁^{a} | 0.0854 |
| wR₂^{b} | 0.2107 |
| GOF^{c} | 1.188 |

Element analysis (%): C₁₈₀H₁₈₀B₆CU₁₂F₁₈N₄₈O₁₈S₂₄W₆ (M.W.=6345.59), Calculated: C, 34.07; H, 2.86; N, 10.59%; Found: C, 33.89; H, 2.99; N, 10.44%.

Infrared spectrum (potassium bromide disk method): 3439 (s), 2968 (m), 2926 (m), 2558 (w), 2185 (w), 1610 (s), 1544 (s), 1496 (w), 1448 (m), 1416 (s), 1384 (w), 1354 (s), 1279 (s), 1260 (s), 1218 (m), 1159 (m), 1065 (m), 1030 (s), 981 (w), 857 (m), 815 (m), 693 (w), 638 (s), 517 (w) cm⁻¹.

Electrospray ionization mass spectrometry (ESI-TOF MS): m/z=1119.9339 ({[2](OTf)}⁵⁺ calculated: 1119.9840), 1437.1539 ({[2](OTf)₂}⁴⁺ calculated: 1437.2180).

¹H NMR spectrum (600 MHz, d₆-DMSO, ppm): δ 8.95 (d, J=6 Hz, 12H), 8.54-8.40 (m, 24H), 7.88 (m, 12H), 6.27 (s, 12H), 5.83 (s, 6H), 2.65 (s, 54H), 2.26 (s, 27H), 1.79 (d, J=12 Hz, 27H).

The data shows that the octahedral tungsten/copper/sulfur cluster compound [Tp*WS₃Cu₂(L^{a})]₆(OTf)₆, that is, [2](OTf)₆, is successfully obtained in this example. The cation skeleton structure of the octahedral tungsten/copper/sulfur cluster compound [2](OTf)₆ is shown in FIG. 3.

### EXAMPLE 3

### Third-order NLO Performance Test of DMF Solutions of Cluster Compounds [1](ReO₄)₄ and [2](OTf)₆.

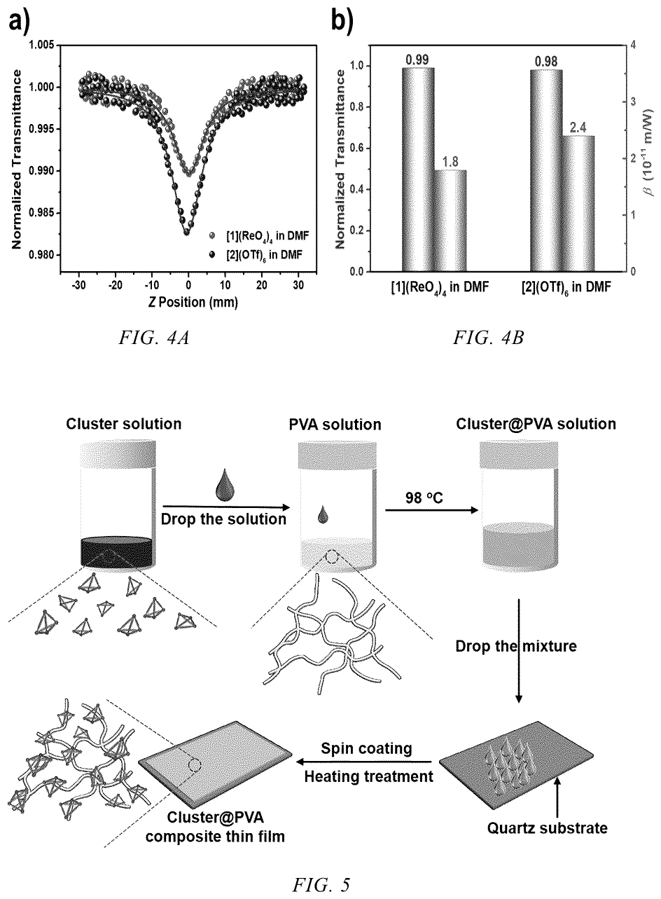

The cluster compounds [1](ReO₄)₄ and [2](OTf)₆ were formulated into 1.38×10⁻⁴ mol/L solutions in DMF. About 150 μL of each solution was placed in a 2 mm quartz cuvette, and fixed on a translation platform controlled by a computer. The sample was moved by the translation platform along the z axis, and Z-scan test was performed at room temperature. The light source used in the test was a frequency-doubled mode-locked Q-switched Nd: YAG laser producing 532 nm polarized light, with a pulse width of 4 ns, a repetition frequency of 10 Hz, and a laser energy of 9.6 μj. The results of Z-scan test are shown in FIG. 4a below. The curves of “sample-focus distance Z” and “normalized transmittance” of these cluster compound solutions all show trough-shaped curve characteristics, indicating that they have reversed saturable absorption response, but the response is weak. The minimum normalized transmittance Tₘᵢₙ of [1](ReO₄)₄ and [2](OTf)₆ solutions are 0.99 and 0.98, respectively, and the effective nonlinear absorption coefficient β are 1.8×10⁻¹¹ m/W and 2.4×10⁻¹¹ m/W, respectively (FIG. 4b).

### EXAMPLE 4

### Preparation of [1](ReO₄)₄@PVA and [2](OTf)₆@PVA Composite Polymer Films

0.25 g of polyvinyl alcohol (PVA, having a polymerization degree of about 1700) was placed in a 20 mL glass bottle, 4 mL of deionized water was added, and the PVA solid was heated and stirred in an oil bath at 98° C. to allow it to become a transparent and uniform PVA viscous solution. A DMF solution (2 mL) of [1](ReO₄)₄ (0.015 g, 0.003 mmol) is added to the PVA solution dropwise, and stirred until an evenly mixed red-brown viscous solution was obtained. A few drops of the viscous solution was taken by a dropper, dripped and spin coated on a quartz sheet of 1.5 cm×1.5 cm. After the spin coating, the viscous solution was slowly dried in a constant-temperature oven at 60° C., to obtain a [1](ReO₄)₄@PVA composite polymer film. By increasing the number of the spin coating process, [1](ReO₄)₄@PVA composite polymer films having 2, 4, 6, 8, 10 and 12 layers can be obtained.

The preparation process of [2](OTf)₆@PVA composite polymer films was the same as that for [1](ReO₄)₄@PVA composite polymer films. During the preparation process, [1](ReO₄)₄ (0.015 g, 0.003 mmol) was replaced by [2](OTf)₆ (0.020 g, 0.003 mmol), and other conditions were the same.

The preparation process is schematically shown in FIG. 5.

### EXAMPLE 5

### Third-order NLO Performance Test of [1](ReO₄)₄@PVA and [2](OTf)₆@PVA Composite Polymer Film Prepared by Spin Coating to have 2, 4, 6, 8, 10 and 12 Layers

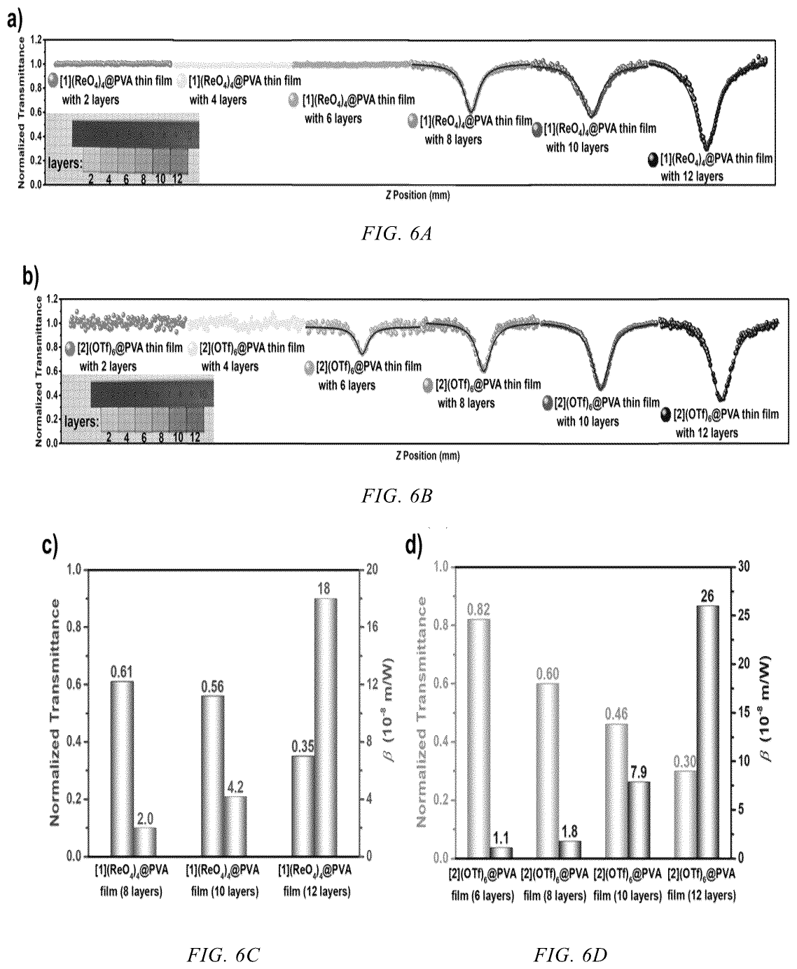

The film sample was directly fixed on a translation platform controlled by a computer and subjected to Z-scan test at room temperature. The laser light source and laser energy used in the test were the same as those in the Z-scan test of the above solution samples. As shown in FIG. 6a, the results of Z-scan test show that [1](ReO₄)₄@PVA composite polymer films prepared by spin coating to have 2, 4, and 6 layers have no any optical response, and the curves of “sample-focus distance Z” and “normalized transmittance” of [1](ReO₄)₄@PVA composite polymer films prepared by spin coating to have 8, 10, and 12 layers show trough-shaped curve characteristics, indicating reversed saturable absorption response. Similarly, the Z-scan curves of [2](OTf)₆@PVA composite film samples also show similar characteristics. As shown in FIG. 6b, [2](OTf)₆@PVA composite films prepared by spin coating to have 2 and 4 layers also have no any NLO response, and [2](OTf)₆@PVA composite films prepared by spin coating to have 6 and more layers show reversed saturable absorption response. With increasing layers in the film, the minimum normalized transmittance Tₘᵢₙ decreases gradually, and the effective nonlinear absorption coefficient β increases, indicating that the third-order NLO response increases gradually (FIGS. 6c and 6d). The [1](ReO₄)₄@PVA composite film prepared by spin coating to have 12 layers has a β value of 1.8×10⁻⁷ m/W, which is 10,000 times that of the solution containing the same. The [2](OTf)₆@PVA composite film prepared by spin coating to have 12 layers has a β value of up to 2.6×10⁻⁷ m/W, which is 10833 times that of the solution containing the same.

Apparently, the [1](ReO₄)₄@PVA and [2](OTf)₆@PVA composite polymer films mentioned in the present invention are ideal third-order NLO material, which not only improves the machinability of the material, but also lays a good foundation for the development of third-order NLO devices.

Apparently, the above-described embodiments are merely examples provided for clarity of description, and are not intended to limit the implementations of the present invention. Other variations or changes can be made by those skilled in the art based on the above description. The embodiments are not exhaustive herein. Obvious variations or changes derived therefrom also fall within the protection scope of the present invention.

What is claimed is:

1. A polyhedral tungsten/copper/sulfur cluster compound, having a chemical formula of: [RWS₃Cu₂(L^{a})]ₙ(M)ₙ,
wherein R is tris(3,5-dimethylpyrazolyl) hydroborate, tris(pyrazolyl)hydroborate, or pentamethylcyclopentadienyl;
L^{a} has a structural formula of: 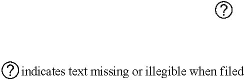
M is selected from triflate and perrhenate, in which when M is ReO₄⁻, n is 4; and when M is OTf⁻, n is 6.

2. A method for preparing a polyhedral tungsten/copper/sulfur cluster compound according to claim 1, comprises steps of: adding a metal sulfur-containing synthon [Et₄N][RWS₃], a ligand L and a cuprous salt to a solvent mixture, reacting with stirring, subjecting the reaction solution to solid-liquid separation, collecting the filtrate, and diffusing with a diffusing agent, to precipitate the polyhedral tungsten/copper/sulfur cluster compound.

3. The method according to claim 2, wherein the molar ratio of the metal sulfur-containing synthon [Et₄N][RWS₃], the ligand L and the cuprous salt is (1-1.5):(1-1.5):(2-2.5).

4. The method according to claim 2, wherein the cuprous salt is selected from [Cu(CH₃CN)₄]ReO₄, and [Cu(CH₃CN)₄]OTf.

5. A composite polymer film material, comprising the polyhedral tungsten/copper/sulfur cluster compound according to claim 1.

6. A method for preparing a composite polymer film material according to claim 5, comprises steps of: adding a solution of a polyhedral tungsten/copper/sulfur cluster compound to a high molecular polymer solution, mixing uniformly, spin coating the obtained liquid onto a substrate, and thermally treating, to obtain the composite polymer film material.

7. The method according to claim 6, wherein the high molecular polymer is selected from the group consisting of polyvinyl alcohol, polymethyl methacrylate, polyimide, polyacrylic alcohol and any combination thereof.

8. The method according to claim 6, wherein the high molecular polymer solution has a concentration of 5.0×10⁻⁴-1.0×10⁻³ mol/L; and the concentration of the solution of the polyhedral tungsten/copper/sulfur cluster compound is 1.6×10⁻³-4.0×10⁻³ mol/L.

9. The method according to claim 6, wherein the composite polymer film material comprises no less than 2 layers.

10. Use of the composite polymer film material according to claim 5 in the preparation of a third-order nonlinear optical material.
